(19) United States
(12) Patent Application Publication
(10) Pub. No.: US 2007/0034195 A1
(43) Pub. Date: Feb. 15, 2007

(54) Control unit, supercharging system, vehicle comprising a supercharging system and method of controlling a supercharging system

(76) Inventors: Jan-Erik Wijk, Kungsbacka (SE); Carl Fredriksson, Kinna (SE)

Correspondence Address: OSTROLENK FABER GERB & SOFFEN, 1180 AVENUE OF THE AMERICAS, NEW YORK, NY, 100368403, US

(21) Appl. No.: 11/440,528

(22) Filed: May 25, 2006

(30) Foreign Application Priority Data
May 25, 2005 (SE) SE 0501177-0

(51) Int. Cl. F02B 33/00

(52) U.S. Cl. 123/565; 123/559.1

(57) ABSTRACT

A control unit for controlling a supercharging system connected to an internal combustion engine for providing a higher air pressure in the air inlet to the engine, is described, said engine being controlled by an engine control module, said control unit arranged to receive a control signal from the engine control module indicating a desired air inlet pressure to the engine and to receive from the supercharging system a pressure signal representing a current air pressure generated in the supercharging system and to control the function of the supercharging system in dependence of the control signal and the at least one air pressure signal. Other control units, for example, for the batteries, may be added to the system to achieve a distributed control system.

### REFERENCE TO RELATED APPLICATION

This application claims the benefit of the filing date of Swedish Patent Application No. SE 0501177-0, filed May 25, 2005, the disclosure of which is hereby incorporated by reference.

### FIELD OF THE INVENTION

The present invention relates to a control unit for controlling a supercharging system as defined in the preamble of claim 1. It also relates to a supercharging system as defined in the preamble of claim 11, a vehicle as defined in the preamble of claim 25 and a method of controlling a supercharging system according to the preamble of claim 27.

### BACKGROUND OF THE INVENTION

In internal combustion engines, the maximum power that can be delivered is limited by the amount of fuel that can be burned efficiently inside the engine cylinders. This in turn is limited by the amount of air that is introduced into each cylinder at each cycle. To improve the efficiency of an engine, therefore, the induced air is often compressed. Increasing the pressure in the air, or air-fuel mixture, entering the engine is referred to as supercharging. Supercharging is particularly useful to increase the torque at engine speeds where the engine for some reason cannot provide the desired torque at atmospheric pressure.

Supercharging can be achieved by a turbocharger, including a compressor and a turbine, which uses energy available in the engine's exhaust gas system to compress the intake mixture.

Supercharging can also be achieved by a separate pump or compressor providing the compressed air to the engine. Such a compressor can also be used together with a turbocharger and may be placed upstream or downstream of the turbocharger. Tests have shown that the interaction between the turbocharger and the separate compressor is optimized if the separate compressor is connected downstream of the turbocharger. The energy available to the turbocharger is dependent on the presence of exhaust gases in the outlet from the engine, which means that the turbocharger will not always be able to provide sufficient compression, while the separate supercharger always has sufficient power from the engine or from a separate power source. On the other hand the driving of the separate supercharger requires a supply of energy. Thus, the two supercharging methods can be used to complement each other.

WO98/54449 discloses a turbo charging system for an internal combustion engine, where a motor driven compressor is used in addition to the turbocharger. The motor driven compressor is controlled by an engine control unit in dependence of signals received from sensors operating at the internal combustion engine, to provide signals of engine speed, throttle position and demands for engine acceleration and engine load. This document also discloses the use of an electric motor to enhance the function of the turbocharger's compressor.

WO 02/10580 discloses an electrically controlled supercharger for use with an internal combustion engine, in particular for use in a car. The compressor is driven by a supercharger motor powered by the car battery, and is controlled by an engine control unit, which calculates an engine torque demand from various input signals indicative of engine and vehicle operating parameters, such as the engine speed, and the position of the accelerator pedal. Based on these parameters, the engine control unit provides a number of output signals to control, among other things, the supercharger. The engine control unit also controls the amount of fuel delivered to the engine

This prior art compressor is controlled by the engine control unit used to control the overall function of the engine. Typically, the engine control unit senses that the air pressure should be increased and orders a corresponding increase in the motor speed of the electric motor driving the compressor. This poses certain difficulties, since the resulting pressure from a certain increase in the motor speed varies with the motor speed value, ambient air pressure etc. Thus, the control of the compressor is not very exact and must be based on trial and error in any given case, that is, if increased compression is required, an increase in motor speed is ordered, the result is evaluated and the motor speed may have to be adjusted again based on the result.

Also, the prior art compressors require a unique control system for each type of car.

To ensure proper cooling of the compressor it is placed close to the air inlet, that is, relatively far away from the engine. Otherwise, the high temperatures developed in the compressor, along with the high pressure, would compromise the function of the compressor.

### OBJECT OF THE INVENTION

It is an object of the present invention to enable a more precise control of the compressor function.

### SUMMARY OF THE INVENTION

This is achieved according to the present invention by a control unit for controlling a supercharging system connected to an internal combustion engine for providing a higher air pressure in the air inlet to the engine, said engine being controlled by an engine control module, said control unit arranged to receive a control signal from the engine control module indicating a desired air inlet pressure to the engine and to receive from the supercharging system a pressure signal representing a current air pressure generated in the supercharging system and to control the function of the supercharging system in dependence the control signal and the at least one air pressure signal.

The object is also achieved by a supercharging system comprising at least one supercharger for use with an internal combustion engine for increasing an inlet air pressure in the air intake to the engine, said engine being controlled by an engine control module, characterized in that the supercharging system is controllable by a control unit arranged to receive from the engine control module a control signal indicating a desired pressure in the air intake to the engine, and that the supercharging system is arranged to communicate to the control unit at least one pressure signal indicating a current air pressure in the supercharging system.

The object is also achieved by method of controlling a supercharging system for use with an internal combustion engine for providing a higher air pressure in the air intake to the engine, said engine being controlled by an engine control module, said method being characterized by the steps of

receiving in a control unit a control signal from the engine control module indicating a desired air pressure in the air intake of the internal combustion engine;

receiving in the control unit at least one air pressure signal from the supercharging system, representing a current air pressure in the supercharging system, and

controlling the supercharging system in dependence of the control signal and the air pressure signal.

The object is also achieved by a vehicle comprising such a control unit and supercharging system.

The arrangement according to the invention enables the control of the compressor with respect to the air pressure, instead of the motor speed of the electric motor driving the compressor. This makes the control more precise and faster than in the prior art.

At the same time, the distribution of control functions to control units closer to the units being controlled, and communicating with the engine control module, enables the installation of the compressor without major modifications to the engine control module. Thus, the invention provides a flexible compressor unit that can be installed in any type of car without significant modification of the control system already present in the car.

The invention also reduces the communication between the engine control module and the units associated with the compressor, thus reducing the EMC.

Prior art solutions to reduce the emission from the engine generally increase the fuel consumption instead. The invention provides a cost efficient solution to this problem in that it enables the reduction of particle emission without increasing the fuel consumption. The feedback from the e-compressor to the control unit also enables monitoring the function of the e-compressor so that any malfunction can be discovered. For efficient catalyst light off, that is, for starting the catalyst as fast as possible, the electrically controlled compressor can be used to supply additional oxygen to the exhaust manifold. The supplied oxygen fuel excessives then combust in order to heat the catalyst after start of the combustion engine. Using the e-compressor to supply this air eliminates the need for a dedicated air pump.

The supercharging system may comprise an electrically controlled compressor driven by an electric motor, a turbocharger, or both. If a turbocharger is provided upstream of the electrically controlled compressor, an air charge cooler is preferably arranged between the turbocharger and the electrically controlled compressor. Alternatively, the air charge cooler may be arranged downstream of the e-compressor. It is also possible, although less feasible, not to provide an air charge cooler at all.

The pressure signal preferably comprises at least one pressure difference signal indicating a pressure difference in the supercharging system, such as the pressure difference generated in the electrically controlled compressor.

Alternatively, or in addition to this, the pressure signal may comprise at least one absolute pressure signal indicating the absolute pressure in a part of the supercharging system, for example, the output pressure from the turbocharger. This is particularly useful when the supercharging system comprises both a turbocharger and an electrically controlled compressor. Having knowledge of the output pressure from the turbocharger and the pressure difference in the electrically controlled compressor enables the control unit to control the supercharging system comprising a turbocharger and electrically controlled compressor as one unit, thereby optimizing the performance.

In one embodiment the control unit further comprises means for receiving at least one temperature signal from the supercharging system, indicative of the temperature in a part of the supercharging system. Monitoring the temperature may be useful to ensure full functionality of the supercharging system. In particular, monitoring the temperature in the air inlet to the turbocharger, together with the output pressure from the turbocharger, enables the control unit to determine the rotational speed of the turbine.

The control unit may also be arranged to receive from a battery control unit battery status information about the status of a battery used to power the supercharging system and control the function of the supercharging system in dependence of the battery status information. In this way a distributed control system for controlling more parts of the vehicle is provided. The distributed control system may also be extended with control units for other parts of the engine system, such as the generator.

A particularly advantageous embodiment of the electrically controlled compressor further comprises guide means for guiding leakage air passing from the electrically controlled compressor in the direction of the electrical motor away from the electrical motor. In this way hot leakage air passing along the drive shaft between the electrically controlled compressor and the electrical motor because of the pressure difference, is guided away from the electrical motor. This hot leakage air, if allowed to pass through the ball bearing and into the motor, would melt the grease in the ball bearing and damage it. The heat could also destroy the magnetic properties of the electrical motor.

In one embodiment the guide means comprises at least two sealing rings for sealing the passage between the electrically controlled compressor and the electrical motor and a passage for letting leakage air pass from between the two sealing rings away from the electrical motor.

The guide means preferably comprises a tube for guiding the leakage air to the air inlet to the supercharging system. This will avoid error in the total mass flow measurement, which may reduce the combustion efficiency.

The embodiment of the electrically controlled compressor comprising guide means could also be used separately, without the control unit. In this case, it would not necessarily comprise the functions for reporting pressure and/or temperature.

### BRIEF DESCRIPTION OF THE DRAWINGS

The present invention will be described in more detail in the following, with reference to the appended drawings, in which:

FIG. 1 illustrates schematically an engine having an electrically controlled compressor connected thereto, according to the present invention;

FIG. 2 illustrates schematically an engine having both a turbocharger and an electrically controlled compressor connected thereto, according to the present invention;

FIG. 3 illustrates a compressor that is capable of being placed further downstream in the air inlet than prior art compressors.

### DESCRIPTION OF PREFERRED EMBODIMENTS OF THE INVENTION

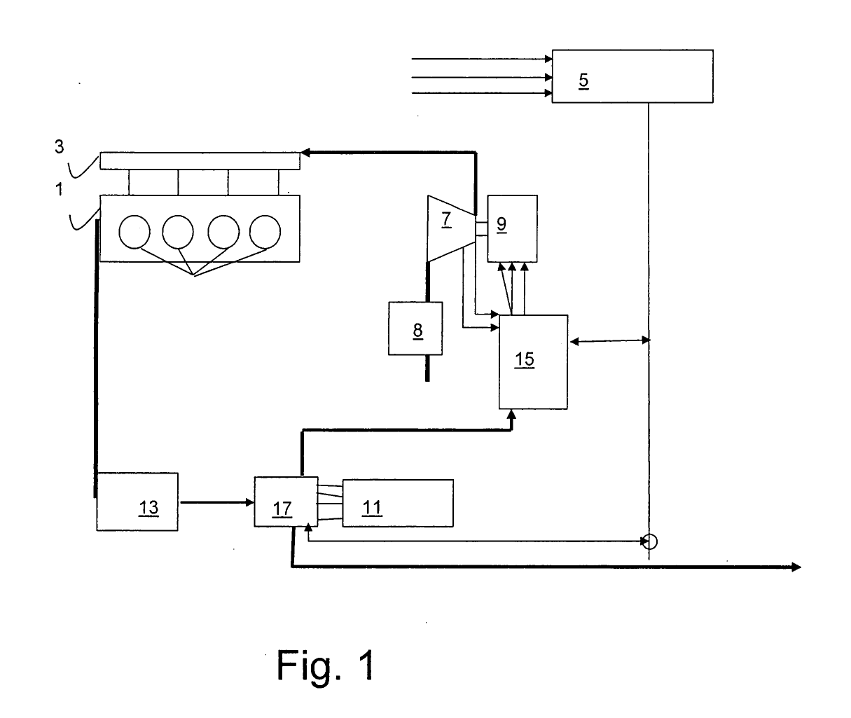

FIG. 1 illustrates schematically the function of an electrically controlled compressor according to the present invention. An internal combustion engine 1 has air, or air-fuel mixture, delivered to it through an inlet 3, as is common in the art. An engine control unit 5 controls the function of the engine 1. To do this, the engine control unit receives various input signals indicative of engine and vehicle operating parameters, such as the engine speed, and the position of the accelerator pedal. Connected to the engine 1 is an electrically controlled supercharger 7, here referred to as the e-compressor. There is an air inlet to the e-compressor, through an air filter, as is common in the art. The e-compressor 7 is driven by an electric motor 9, which is powered by a battery 11. Preferably, but not necessarily, the battery is charged by a generator 13 driven by the engine 1. The battery can be the same battery that is used for the starting, lighting and ignition requirements of the vehicle, but is preferably a separate battery designed to fit the requirements of the e-compressor, which requires a very large current compared to the vehicle's other functions. Preferably, the battery used for the e-compressor should provide a voltage of at least 24V.

According to the invention a motor control unit 15 is provided. The motor control unit 15 comprises a microprocessor arranged to control the electric motor 9 and also receives control signals from the engine control module 5. When the pressure of the inlet air to the engine 1 should be increased, the engine control module 5 orders the motor control unit to arrange this. The motor control unit 15 receives a feedback signal from the e-compressor 7, indicative of the pressure difference in the e-compressor. Alternatively, pressure sensors may report the inlet pressure to and outlet pressure from the e-compressor, respectively, or just the outlet pressure. Thus, the motor control unit 15 can control the e-compressor in direct dependence of the sensed pressure at any given time. The motor control unit 15 also knows if a pressure requested by the engine control module 5 can be delivered by the e-compressor.

The engine control module 5 also receives feedback signals from the motor control unit 15, for example, relating to the motor speed of the electric motor 9. In this way, the engine control module 5 can monitor the overall function of the compressor 7 and the motor 9 and motor control unit 15.

According to the invention, preferably, a battery control unit 17 is also provided. The battery control unit 17 controls the charging and discharging of the battery 11 and is also controlled by the engine control module 5. The battery control module may be used to control several batteries and capacitor packs having different capacity and voltage. The battery control unit preferably controls the charging and discharging of the batteries and capacitor packs. The power consumption is altered between the different batteries in order to keep all platform critical functions working and maintain high battery lifetimes. The different batteries can then be used in order to keep all platform critical functions working and maintain a long lifetime of the batteries.

Alternatively, the electric motor 9 could be powered directly from the generator 13. To achieve the desired efficiency, the supply voltage to the electric motor 9 should preferably be 24 volts, while the generator is arranged to supply 12 volts. This can be remedied by adding another winding in the generator, adapted to supply a 24 V voltage.

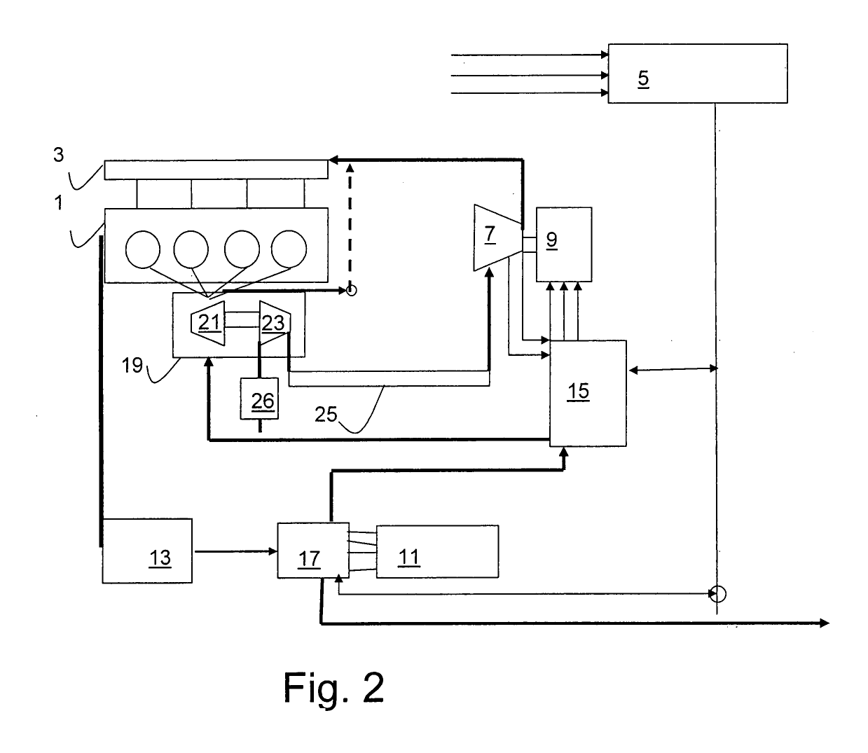

FIG. 2, in which like components are indicated by the same reference numerals as in FIG. 1, shows an internal combustion engine 1 similar to the one in FIG. 1. As in FIG. 1, the engine 1 is controlled by an engine control module 5 and a supercharger 7 driven by an electric motor 9 is controlled by a motor control unit 15 similar to the one in FIG. 1. A battery 11 controlled by a battery control unit 17 provides power to the e-compressor 7, or the e-compressor may be powered from the generator as discussed in connection with FIG. 1.

In FIG. 2, a turbocharger 19 comprising a turbine 21 and a compressor 23 is also present. As is common in the art, the turbine 21 is driven by the exhaust gases from the engine outlet. The output of compressed air from the compressor 23 is input to the e-compressor 7 through an air charge cooler 25. There is an air inlet to the compressor 23 through an air filter 26 as is common in the art. In FIG. 2, the control unit 15 controls both the e-compressor 7 and the turbocharger 19.

It would be possible to control only the e-compressor. The pressure sensor or sensors in this embodiment may provide the same signals as discussed in connection with FIG. 1.

The control unit 15 can also be used to control only a turbocharger, if no e-compressor is present. If the supercharging system comprises both a turbocharger and an e-compressor the same control unit can be used to control both the turbocharger and the e-compressor, or only one of them. Alternatively separate control units could be used for the turbocharger and the e-compressor. The most advantageous solution would be, as shown in FIG. 2, to let one control unit control the entire supercharging system, including both the turbocharger and the e-compressor when both are present.

In this latter case the control unit should preferably receive pressure signals from both the turbocharger and the e-compressor, to have information about what can be achieved by each supercharger at any given time. Preferably, the output pressure from the turbocharger and the pressure difference in the e-compressor should be reported to the control unit.

Each of the superchargers 7, 19 could also report the temperature of the air present in the supercharger to the control unit 15. Information about the temperature of the air in the air inlet to the turbocharger 19 will be especially useful as it will, in conjunction with the output pressure from the turbocharger, enable the control unit to determine the rotational speed of the turbine.

As an alternative to the configuration shown in FIG. 2, the charge cooler can be placed downstream of the e-compressor, so that the output of compressed air from the compressor 23 is fed directly to the e-compressor 7. Exhaust gas recirculation may be provided from the engine's outlet to the manifold inlet in a manner well known in the art.

In each of the embodiments discussed above, the communication between the engine control module 5 and the motor control unit 15, and between the engine control module 5 and the battery control unit 17 preferably takes place on the data bus commonly used for communication in car engines, such as a CAN bus. This provides a standardized interface to the control units 15, 17 from the engine control module 5. Therefore the supercharging system of the invention can be made independent of the type of car. The supercharging system can comprise the supercharger 7, the electric motor 9 and the motor control unit 15 as in FIG. 1. The supercharging system can also comprise the turbocharger 19 and the motor control unit 15. In the case when both a turbocharger and an e-compressor they can also be controlled by two different control units, or only one of them can be controlled, but it is advantageous for one control unit to control the entire supercharging system.

The same is valid for the battery control unit 17, which can monitor closely each of the batteries and capacitors it controls. Other distributed control units can be provided as well, each being responsible for control functions close to a component of the car, for example, for controlling the function of the generator.

For example, if an electric motor is used to enhance the function of the turbocharger, like in WO98/54449, the control unit 15, or a separate control unit could be used to control the function of the electric motor.

The method of operation is as follows, if the supercharging system controlled by the control unit comprises only an electrically controlled compressor:

The engine control module 5 registers the pressure in the inlet manifold 3 of the internal combustion engine 1. The engine control module 5 also receives information about the level of depression of the car's accelerator and the engine speed, and calculates a desired value for the inlet air pressure in the inlet manifold based on this. These first two steps are carried out according to the prior art. If the inlet air pressure is less than the desired value, the engine control module 5 sends a signal to the motor control unit 15 indicating the desired pressure. The motor control unit 15 controls the electric motor 9 to deliver a certain power to the e-compressor 7. The e-compressor 7 registers the air pressure at its inlet and outlet and reports these values to the motor control unit 15. Alternatively, only the pressure difference between the inlet and the outlet of the compressor is reported. In a simplified version the e-compressor 7 registers and reports only the outlet air pressure to the motor control unit 15. The motor control unit 15 can then control the power delivered by the electric motor 9 in dependence of the relationship between the desired air pressure, as indicated by the engine control module 5, and the actual air pressure as reported by the e-compressor 7. Thereby, the motor control unit 15 controls the pressure in the e-compressor 7, and thus the air inlet pressure to the combustion engine 1, in dependence of the actual current pressure in the e-compressor.

If the supercharging system comprises only a turbocharger the control unit controls the turbocharger in a similar way as above, by controlling the power boost control unit of the turbocharger. The most common type of boost controls are through waste gate or variable turbine geometry manipulation.

If the supercharging system comprises both a turbocharger and an e-compressor, the e-compressor is preferably connected downstream of the turbocharger as shown in FIG. 2. In this case, if the control unit receives an indication from the turbocharger of the absolute output pressure from the turbocharger and the pressure difference of the e-compressor, it will have complete information about the supercharging system and will be able to control the supercharging system for optimal performance.

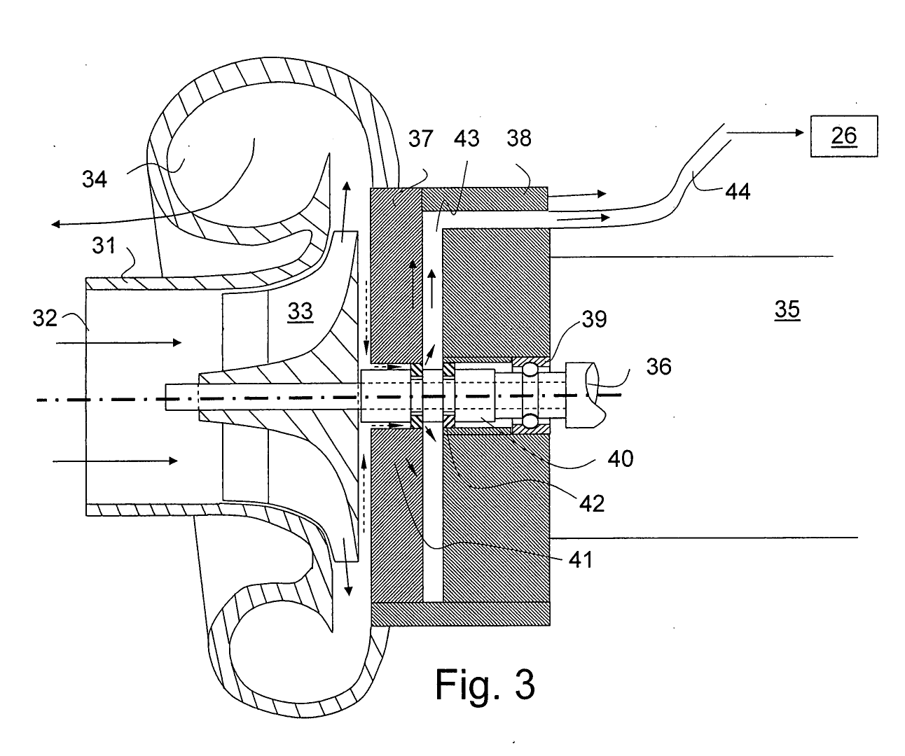

FIG. 3 is a cross-sectional view of construction of the e-compressor that will enable the e-compressor to be placed downstream of the air charge cooler, as shown in FIG. 2. Placing the e-compressor in the air inlet flow as close as possible to the inlet manifold is advantageous because it enables a more direct control of the air inlet pressure to the engine. It also enables more efficient use of the energy generated in the turbine compared to a solution where the e-compressor is located upstream in the air inlet flow, that is, close to the air filter, such as disclosed in WO 02/10580.

With conventional e-compressors, such as the one disclosed in WO 02/10580 the air temperature and the pressure should be kept relatively low. With a conventional e-compressor, some of the air passing through the e-compressor will leak out from the e-compressor along the drive shaft connecting the e-compressor to the motor driving it. The air will pass through the bearing element, and some of it will reach the electric motor. This should be limited by limiting the pressure. If the leaking air is too hot, the grease of the bearing element will melt, which will damage the bearing element. The heat may even destroy the magnetic components of the electric motor so that the motor will cease to function. Therefore, an e-compressor like the one in WO 02/10580 must be placed upstream of the turbocharger's compressor, near the air inlet filter, in order not to be destroyed. Near the air inlet filter the pressure is close to one atmosphere and the air has the ambient temperature. Downstream of the turbocharger, the air pressure may typically be around 3 atmospheres and the temperature may be 120° C.

In the e-compressor shown in FIG. 3, as in conventional e-compressors, some of the pressurized air in the e-compressor will leak out along the drive shaft towards the ball bearing. This is avoided according to an embodiment of the invention, by an e-compressor designed as shown in FIG. 3.

The compressor shown in FIG. 3 comprises a compressor unit 31 having an air intake 32 for receiving incoming air. In the situation shown in FIG. 1 the air will be received from the air inlet through the air filter only. In the situation shown in FIG. 2 the air will be received from the air charge cooler 25. The direction of flow of the air through the compressor is indicated by solid arrows. As is common in the art the compressor also comprises a compressor wheel 33 and an air discharge 34 for feeding compressed air to the engine inlet manifold. The compressor is driven by an electric motor 35, via a motor shaft 36. Between the compressor 1 and the motor 35, around the shaft 36, a compressor sealing plate 37 for sealing off the compressor is arranged adjacent the compressor unit 31 and a motor front sealing plate 38 is arranged adjacent the electric motor 35. A ball bearing 39, or other type of bearing element, is arranged between the drive shaft 36 and the motor front sealing plate 38 in a manner known in the art.

As indicated by the dashed arrows, air will flow from the compressor 31 into the channel formed between the shaft 36 and the compressor sealing plate 37. In a conventional compressor unit this air would flow through the channel formed between the shaft 36 and the motor front sealing plate 38. In order to avoid this leakage, the shaft is provided with a rotating sealing collar 40 having a first and a second groove to receive a first and a second sealing ring 41, 42 provided around the shaft 36. Between these sealing rings 41, 42 an air leakage passage 43 is provided, through which the leakage air can be guided away from the compressor and thus never reach the ball bearing 39 and the electric motor unit 35. The sealing rings in this embodiment are labyrinth type sealing rings.

Preferably, as shown in FIG. 3, the first sealing ring 41 is provided in the compressor sealing plate 37, the second sealing ring 42 is provided in the motor front sealing plate 38 and the passage is formed between the compressor sealing plate 37 and the motor front sealing plate 38.

The outlet from the passage 43 is connected through a hose 44 to the air inlet, just after the air filter 26, (Or reference numeral 8 in FIG. 1) so that no air is released in an uncontrolled manner. This is done to ensure that the registered amount of air that is fed to the combustion engine is correct. An erroneous amount of inlet air will lead to the supply of the wrong amount of fuel to the engine.

What is claimed is:

1. A control unit for controlling a supercharging system connected to an internal combustion engine for providing a higher air pressure in the air inlet to the engine, said engine being controlled by an engine control module, said control unit being arranged to receive a control signal from the engine control module indicating a desired air inlet pressure to the engine and to receive from the supercharging system a pressure signal representing a current air pressure generated in the supercharging system and to control the function of the supercharging system in dependence of the control signal and the at least one air pressure signal.

2. A control unit according to claim 1, arranged to control a supercharging system comprising an electrically controlled compressor driven by an electric motor.

3. A control unit according to claim 1, arranged to control a supercharging system comprising a turbocharger.

4. A control unit according to claim 1, arranged to control a supercharging system comprising an electrically controlled compressor and a turbocharger.

5. A control unit according to claim 1, wherein said at least one pressure signal comprises at least one pressure difference signal indicating a pressure difference in the supercharging system.

6. A control unit according to claim 5, wherein said pressure difference signal relates to the pressure difference in the electrically controlled compressor.

7. A control unit according to claim 1, wherein said at least one pressure signal comprises at least one absolute pressure signal indicating the absolute pressure in a part of the supercharging system.

8. A control unit according to claim 7, wherein the absolute pressure signal indicates the pressure in the air outlet from the turbocharger.

9. A control unit according to claim 1, further comprising means for receiving at least one temperature signal from the supercharging system, indicative of the temperature in a part of the supercharging system.

10. A control unit according to claim 1, further arranged to receive from a battery control unit battery status information about the status of a battery used to power the supercharging system and control the function of the supercharging system in dependence of the battery status information.

11. A supercharging system comprising at least one supercharger for use with an internal combustion engine for increasing an inlet air pressure in the air intake to the engine, said engine being controlled by an engine control module, wherein the supercharging system is controllable by a control unit arranged to receive from the engine control module a control signal indicating a desired pressure in the air intake to the engine, and that the supercharging system is arranged to communicate to the control unit at least one pressure signal indicating a current air pressure in the supercharging system.

12. A supercharging system according to claim 11, comprising a turbocharger.

13. A supercharging system according to claim 11, comprising an electrically controlled compressor driven by an electric motor.

14. A supercharging system according to claim 11, arranged to receive on its air inlet compressed air from a turbocharger.

15. A supercharging system according to claim 14, arranged to received said compressed air from a cooling device connected between the turbocharger's outlet and the inlet of the electrically controlled compressor.

16. A supercharging system according to claim 11, arranged to receive on its air inlet an air pressure of substantially 1 atmosphere.

17. A supercharging system according to claim 11, arranged to communicate to the control unit a pressure difference signal indicating a pressure difference in part of the supercharging system.

18. A supercharging system according to claim 17, wherein said pressure difference signal relates to the pressure difference in the electrically controlled compressor.

19. A supercharging system, according to claim 11, arranged to communicate to the control unit an absolute pressure signal indicating the absolute pressure in a part of the supercharging system.

20. A supercharging system according to claim 19, wherein the absolute pressure signal indicates the pressure in the air outlet from the turbocharger.

21. A supercharging system according to claim 11, further comprising means for reporting at least one temperature signal to the control unit, indicative of the temperature in a part of the supercharging system.

22. A supercharging system according to claim 13, further comprising guide means for guiding leakage air passing from the electrically controlled compressor in the direction of the electrical motor away from the electrical motor.

23. A supercharging system according to claim 22, wherein the guide means comprises at least two sealing rings for sealing the passage between the electrically controlled compressor and the electrical motor and a passage for letting leakage air pass from between the two sealing rings away from the electrical motor.

24. A supercharging system according to claim 22, wherein the guide means comprises a tube for guiding the leakage air to the air inlet to the supercharging system.

25. A vehicle comprising an internal combustion engine for driving the vehicle and an engine control module for controlling the internal combustion engine in dependence of vehicle parameters, said vehicle being wherein it comprises a supercharging system according to claim 11, by a control unit for controlling a supercharging system connected to an internal combustion engine for providing a higher air pressure in the air inlet to the engine, said engine being controlled by an engine control module, said control unit being arranged to receive a control signal from the engine control module indicating a desired air inlet pressure to the engine and to receive from the supercharging system a pressure signal representing a current air pressure generated in the supercharging system and to control the function of the supercharging system in dependence of the control signal and the at least one air pressure signal.

26. A vehicle according to claim 25 further comprising at least one battery being charged from a generator driven by the internal combustion engine, further comprising a battery control unit arranged to control the charging and discharging of the at least one battery in dependence of control signals received from the engine control module and in dependence of the status of the at least one battery.

27. A method of controlling a supercharging system for use with an internal combustion engine for providing a higher air pressure in the air intake to the engine, said engine being controlled by an engine control module, said method wherein by the steps of receiving in a control unit a control signal from the engine control module indicating a desired air pressure in the air intake of the internal combustion engine; receiving in the control unit at least one air pressure signal from the supercharging system, representing a current air pressure in the supercharging system, and controlling the supercharging system in dependence of the control signal and the air pressure signal.

28. A method according to claim 27 wherein the supercharging comprises a turbocharger.

29. A method according to claim 27, wherein the supercharging system comprises an electrically controlled compressor driven by an electrical motor.

30. A method according to claim 27, further comprising providing to the air inlet of the supercharging system compressed air from a turbocharger.

31. A method according to claim 27, further comprising providing to the air inlet of the supercharging system an air pressure of substantially 1 atmosphere.

32. A method according to claim 27, wherein the step of receiving an air pressure signal in the control unit comprises receiving a pressure difference signal indicating a pressure difference in the supercharging system.

33. A method according to claim 32, wherein the pressure difference signal relates to a pressure difference in the electrically controlled compressor.

34. A method according to claim 27, wherein the step of receiving an air pressure signal in the control unit comprises receiving an absolute pressure signal indicating an absolute pressure in a part of the supercharging system.

35. A method according to claim 27, further comprising the step of providing from the supercharging system to the control unit at least one temperature signal indicative of the temperature in a part of the supercharging system.

36. A method according to claim 27, further comprising the step of controlling the function of the supercharging system in dependence of battery status information received from a battery control unit.
